(19) United States
(12) Patent Application Publication
(10) Pub. No.: US 2004/0196279 A1
(43) Pub. Date: Oct. 7, 2004

(54) Device for adjusting control signals for an LCD

(76) Inventors: Jin Tak Kim, Kyoungki-do (KR); Yong Il Kim, Kyoungki-do (KR)

Correspondence Address: LADAS & PARRY, 224 SOUTH MICHIGAN AVENUE, SUITE 1200, CHICAGO, IL, 60604, US

(21) Appl. No.: 10/700,096

(22) Filed: Nov. 3, 2003

(30) Foreign Application Priority Data
Apr. 1, 2003 (KR) 2003-20586

(51) Int. Cl. G09G 3/36

(52) U.S. Cl. 345/211

(57) ABSTRACT

A device for adjusting control signals for an LCD makes it possible to externally adjust the control signals from an outside. The device includes an LCD module having an LCD panel for displaying a picture, a timing controller for adjusting a data supply and a driving signal, a voltage generating unit for generating a driving voltage, and an input unit provided with a plurality of control signal pins which are adjusted by an external adjustment signal; and a conversion board device having a scaler unit for generating and providing data and a power supply required for the LCD module and a power supply unit. The scaler is provided with microcomputer GPIO ports, and the microcomputer GPIO ports control the plurality of control signal pins provided in the input unit.

### BACKGROUND OF THE INVENTION

1. Field of the Invention

The present invention relates to a liquid crystal display (LCD), and more particularly to a device for adjusting control signals for an LCD which can provide convenience to a user and perform accurate tuning of an LCD module.

2. Description of the Prior Art

FIG. 1 is a block diagram explaining a general LCD and a method of driving the LCD.

Referring to FIG. 1, the LCD includes an LCD module 100 having an LCD panel 106 provided with a gate driver 100 and a source driver 104, a backlight unit 108, a timing controller 110 for driving the LCD panel, a voltage generating unit 112, a control signal generating unit 114, and an input unit 116 for receiving signals for controlling the above units from an outside; and a conversion board device 200 for generating and providing signals for driving the LCD module to the input unit.

The timing controller 110 in the LCD module 100 controls a data signal, a clock signal and various kinds of control signals REV, TP, POL, etc., so that the gate and source drivers 102 and 104 can drive the LCD panel. The voltage generating unit 112 generates a common voltage, Von, Voff, etc., and drives the source and gate drivers. The control signal generating unit 114 generates and provides various kinds of control signals FRC_enable, LVDS_MAP_SEL, TDDI, POL_SELECT, etc., to the timing controller 110.

A scaler unit 202 in the conversion board device 200 digitalizes and scales data and various kinds of input signals to match the LCD module, and a power supply unit 204 provides a power supply required for driving the backlight unit to the LCD module 100.

In the case of driving the LCD as described above, the control signals for controlling the LCD panel and the common voltage signals are directly generated in the LCD module. However, if the picture quality of the LCD module deteriorates or any problem occurs when a manufacturer manufactures monitors using the LCD module, it is impossible for the manufacturer to adjust the LCD module itself. Consequently, the LCD module should be resent to an LCD module manufacturer for repair, and this is time-consuming and causes the monitor manufacturer inconvenience in manufacturing the monitors.

### SUMMARY OF THE INVENTION

Accordingly, the present invention has been made to solve the above-mentioned problems occurring in the prior art, and an object of the present invention is to provide a device for adjusting control signals for an LCD which can provide a user with convenience in adjustment of the LCD module and enable a manufacturer to directly adjust the LCD module during any process, including a manufacturing process, if the LCD module is out of order, by making it possible to externally adjust control signals and a common voltage signal.

In order to accomplish this object, there is provided a device for adjusting control signals for an LCD, comprising an LCD module having an LCD panel for displaying a picture, a timing controller for adjusting a data supply and a driving signal, a voltage generating unit for generating a driving voltage, and an input unit provided with a plurality of control signal pins which are adjusted by an external adjustment signal; and a conversion board device having a scaler unit for generating and providing data and a power supply required for the LCD module and a power supply unit, wherein the scaler is provided with microcomputer GPIO ports, and the microcomputer GPIO ports control the plurality of control signal pins provided in the input unit.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram explaining a general LCD and a method of driving the LCD.

FIG. 2 is a block diagram explaining an LCD module and an external device for driving the LCD module according to the present invention.

FIG. 3 is a table showing an example of names, function, and setting methods for signals to be controlled;

FIGS. 4a and 4b are a block diagram and a circuit diagram of various control signal pins constructed in an input unit of an LCD module actually produced by the assignee of the present application; and

FIG. 5 is a circuit diagram of a circuit for outputting the common voltage according to the present invention.

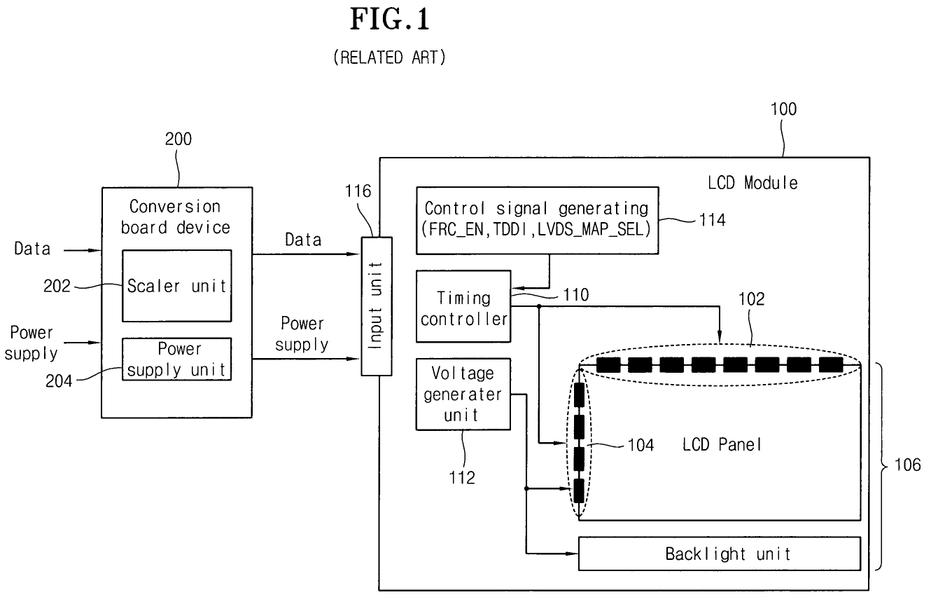

### DETAILED DESCRIPTION OF THE PREFERRED EMBODIMENT

Hereinafter, a preferred embodiment of the present invention will be described with reference to the accompanying drawings. In the following description and drawings, the same reference numerals are used to designate the same or similar components, and so repetition of the description on the same or similar components will be omitted.

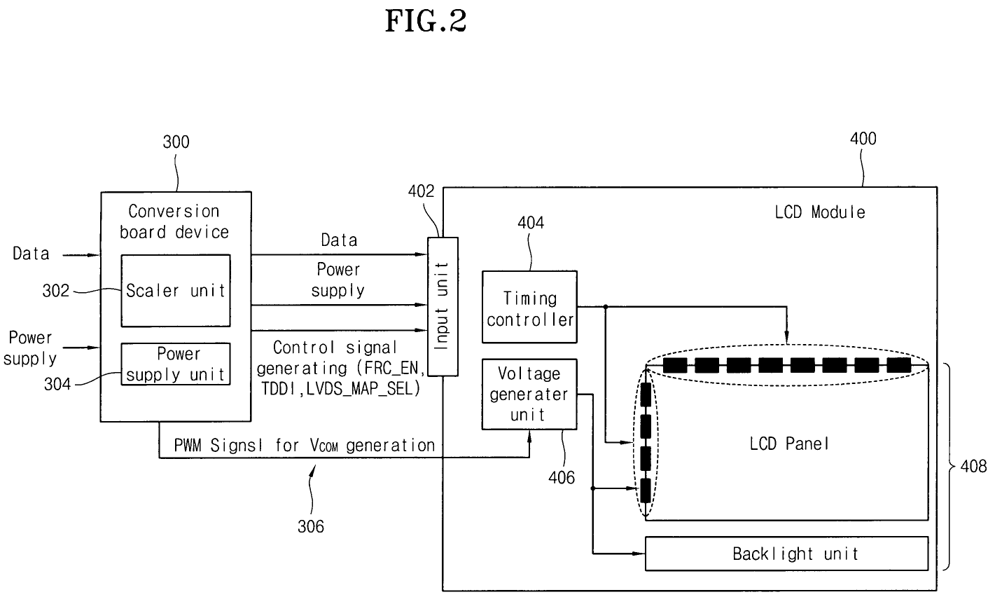

FIG. 2 is a block diagram explaining an LCD module and an external device for driving the LCD module according to the present invention.

As shown in FIG. 2, the device according to the present invention briefly comprises an LCD module 400 and a conversion board device 300.

The conversion board device 400 includes a scaler unit 302 for digitalizing various kinds of input signals inputted to the LCD module 300 and scaling the input signals to match the LCD module, and a power supply unit 304 for supplying a power supply required for driving the LCD module.

Here, the scaler unit 302 is provided with a microcomputer GPIO port having a function of adjusting various kinds of control signals for controlling the LCD module, and the conversion board device 300 outputs a pulse width modulation (PWM) signal 306 to adjust the common voltage Vcom.

The LCD module 400 includes an input unit 402, a timing controller 404, a voltage generating unit 406, and an LCD panel 408 provided with source and gate drivers and a backlight unit.

The input unit 402 is provided with control pins which are signal terminals such as FRC_Enable, LVDS_MAP_SEL, TDDI, and POL_Select signals terminals for controlling functions of the LCD panel 408. The signals are converted into control signals that match the LCD module according to the control signals of the microcomputer GPIO port mounted on the scaler unit 302, and the converted signals are transferred to the timing controller 404. Also, the PWM common voltage signal 306 is outputted to the voltage generating unit 406.

The timing controller 404 divides the control signals and the driving voltage from the input unit 402 into signals required for the respective driving devices, distributes the data signal to the source driver, and controls the gate driver.

The voltage generating unit 406 converts the common voltage and the power supply transferred from the input unit 402 into reference voltages and driving voltage, and transfers them to the respective driver ICs.

In other words, the control signal terminals required for driving and controlling the LCD panel 408 are constructed as control pins, and mounted on the input unit of the LCD panel. The control pins are properly adjusted by software to match the LCD module using the microcomputer GPIO port mounted on the scaler unit, and thus even if the LCD module is out of order during its adjustment, it can be externally adjusted without being touched by the manufacturer.

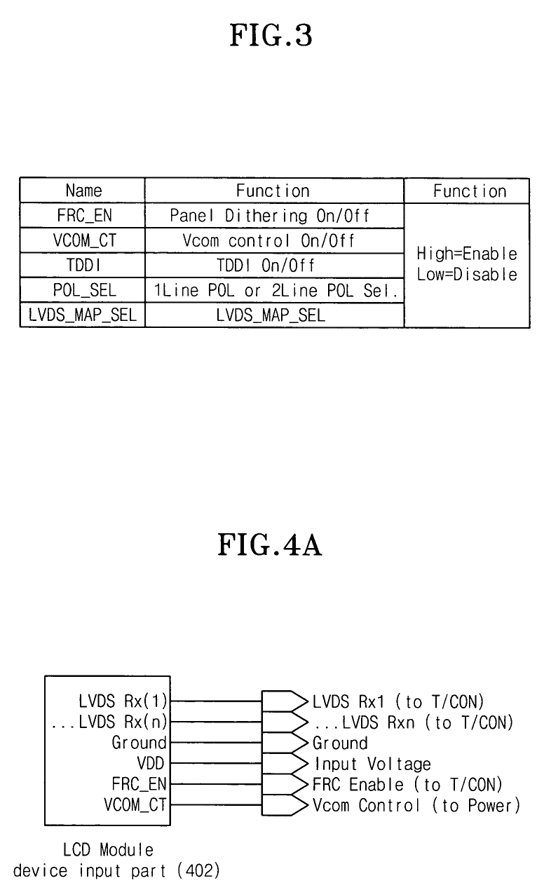

FIG. 3 is a table showing signals to be controlled.

As shown, the FRC_EN signal terminal is a signal for determining whether to use dithering of the LCD panel or not and is set in a manner using a high/low selection signal. The VCOMP_CT signal is a signal for determining whether to use a common voltage in the LCD module and a common voltage outputted from the conversion board device or not and is set in a manner using a high/low selection signal. Also, the following signals of TDDI (Transition Dependent Data Inversion), POL_SEL, LVDS_MAP_SEL, etc., are signals for determining the characteristics of the LCD and can be set in the same manner.

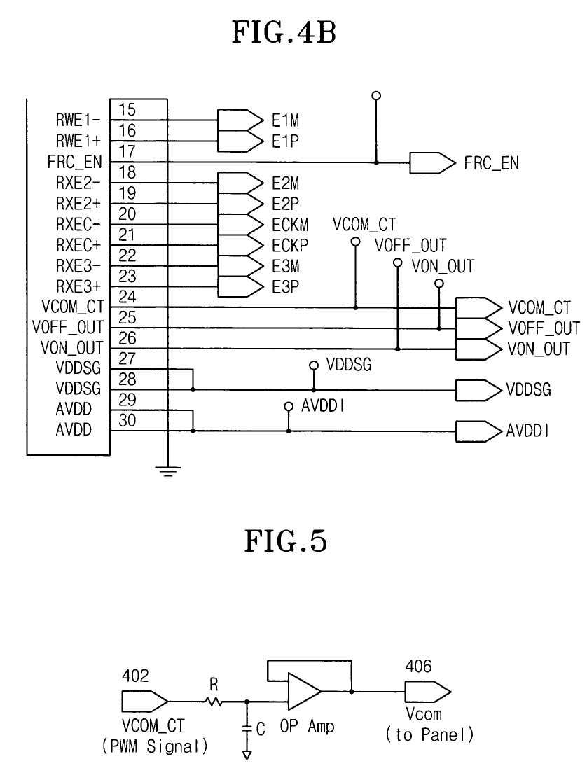

FIGS. 4a and 4b are a block diagram and a circuit diagram of various control signal pins constructed in an input unit of an LCD module actually produced by the assignee of the present application

FIG. 5 is a circuit diagram of the circuit for outputting the common voltage according to the present invention.

As illustrated in FIG. 5, the common voltage outputting circuit includes an OP amplifier arranged in the input unit of the LCD module, and generates the Vcom voltage according to the PWM signal outputted from the conversion board using the OP amplifier.

As described above, according to the LCD of the present invention, control signals are changed externally from the LCD module, and the values of such control signals are not fixedly adjusted during the development of the LCD module, but can be continuously adjusted during the manufacturing process. Accordingly, the completion of the product is heightened, and the product can cope with diverse needs of customers to secure a larger custom.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A device for adjusting control signals for an LCD, comprising:
an LCD module having an LCD panel for displaying a picture, a timing controller for adjusting a data supply and a driving signal, a voltage generating unit for generating a driving voltage, and an input unit provided with a plurality of control signal pins which are adjusted by an external adjustment signal; and
a conversion board device having a scaler unit for generating and providing data and a power supply required for the LCD module and a power supply unit;
wherein the scaler is provided with microcomputer GPIO ports, and the microcomputer GPIO ports control the plurality of control signal pins provided in the input unit.

2. The device as claimed in claim 1, wherein the plurality of control signal pins are for signals of FRC_EN, TDDI, LVDS_MAP_SEL, and the signals are properly adjusted under the control of the microcomputer GPIO ports to be transferred to the controller.

3. The device as claimed in claim 1, wherein the conversion board device generates a PWM signal for adjusting a common voltage.
